(19) United States
(12) Patent Application Publication
(10) Pub. No.: US 2002/0178067 A1
(43) Pub. Date: Nov. 28, 2002

(54) Equipment supply method

(76) Inventors: Jeremy John Carroll, Golden Hill (GB); Christopher Tofts, Iron Acton (GB)

Correspondence Address: HEWLETT-PACKARD COMPANY, Intellectual Property Administration, P.O. Box 272400, Fort Collins, CO, 80527-2400, US

(21) Appl. No.: 10/151,004

(22) Filed: May 21, 2002

(30) Foreign Application Priority Data
May 23, 2001 (GB) 0112470.0

(51) Int. Cl. G06F 17/60

(52) U.S. Cl. 705/22; 705/28

(57) ABSTRACT

This invention concerns an equipment supply method in which a high degree of reliability is assured and in which unscheduled visits by maintenance engineers to end users may be minimized. In a first step, the method comprises making an assessment of predicted user demand over a given time period for equipment usage. In a next step, an oversupply function is applied to the predicted user demand over the given time period to provide a safety factored predicted demand function. From the safety factored predicted demand, a number of equipment units required for supply is calculated and the equipment units supplied to the user. Equipment usage is then monitored over the given time period and if actual user demand deviates from predicted user demand during the time period, then the number of equipment units supplied to the user is modified at the next convenient opportunity.

### FIELD OF THE INVENTION

The invention relates to an equipment supply method, program product and system, and particularly, but not exclusively, to a method program product and system for supplying printers, monitoring printer usage and maintaining printers.

### BACKGROUND OF THE INVENTION

In an environment such as a print shop, there is a requirement for reliable printing at a given demand level. The number of printers used in a print shop is typically chosen by the customer, i.e. the print shop. Naturally, the more printers chosen, the more capital expenditure is required by the print shop and there is a temptation by the print shop to choose a number which may be less than the economical optimum so that if a printer breaks down it is imperative to have that printer replaced or repaired with only a short time delay. When a printer stops operating, or stops operating efficiently it is imperative in this scenario to get a quick call-out time from maintenance staff—something which is not always possible. The customer, of course, may choose to modify the number of printers and will pay for the privilege of such modification.

Another means by which a customer may pay for printing equipment is to lease that equipment and pay on a “click charge” basis. Click charging generally has charging according to utilisation bands so as to favour high utilisation—in other words, the more clicks, the less the charge per click.

From a customer convenience point of view, it is often irrelevant to the customer how many printers are actually available for use, the critical parameters however are that there must be sufficient printers to deal with the jobs in hand and those jobs should not take more than an acceptable time to complete. A measure of the acceptability of a print time is given by the so-called “click to clunk” parameter which is a measure of the time between a user initiating a print job from a PC to the time it takes the printer to output that job.

### SUMMARY OF THE INVENTION

It is an aim of preferred embodiments of the present application to provide an equipment supply method in which user requirements are met and the number of emergency call outs to a user's site is minimised.

According to a first aspect of the invention, there is provided a method of equipment supply to a user, the method comprising:

(i) making an assessment of predicted user demand over a given time period for equipment usage;

(ii) applying an oversupply function to the predicted user demand over the given time period to provide a safety factored predicted demand function;

(iii) calculating the number of equipment units which are required for supply to the user to meet the safety factored predicted demand over the given time period;

(iv) supplying the equipment units to the user;

(v) monitoring actual equipment usage over the given time period; and

(vi) if actual user demand deviates from predicted user demand during said time period modifying the number of equipment units supplied to the user accordingly at the next convenient opportunity.

According to a second aspect of the invention, there is provided a method of equipment supply to a user, the method comprising:

(i) making an assessment of predicted user demand over a given time period for equipment usage;

(ii) calculating the number of equipment units which are required for supply to the user when working within a reliability band for those equipment units, to meet the predicted user demand over the given time period;

(iii) adding a number of extra equipment units to the number calculated in step (ii);

(iv) supplying the equipment units to the user;

(v) monitoring actual equipment usage over the given time period; and

(vi) if actual user demand deviates from predicted user demand during said time period, modifying the number of equipment units supplied to the user accordingly at the next convenient opportunity.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic block diagram showing a typical bus based computer network comprising a plurality of work stations, a server, a plurality of printers and a printer server; and

FIG. 2 shows various different supply and demand functions.

FIG. 3 is a schematic block diagram flowchart of an embodiment of the present invention.

FIG. 4 is a schematic block diagram flowchart of a further embodiment of the present invention.

### DETAILED DESCRIPTION OF THE PREFERRED EMBODIMENT

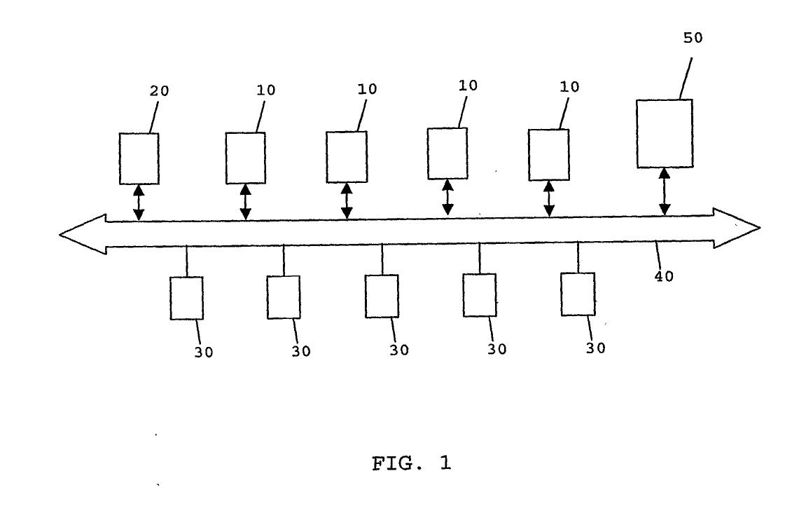

Referring now to FIG. 1, there is shown a bus based system in which work stations 10, a server 20, printers 30 and a print server 50 communicate via a common bus 40.

In accordance with aspects of the invention, printers 30 are desirably supplied by a printer supplier in such a manner so as to ensure that copies are delivered speedily (to a given click to clunk time) and reliably.

When deciding an initial number of printers to supply to the user for use in the network of FIG. 1, advantage may be taken of any pre-existing statistics which the user may have concerning number of print copies required over time. Alternatively, an initial prediction may be made based upon the numbers and capacities of printers pre-existing at the user site.

In conjunction with the user, it is possible from the statistics obtained concerning printer usage in the past and based upon the user's prediction of business expansion to calculate an initial predicted user demand. This prediction can be used to build up a prediction curve.

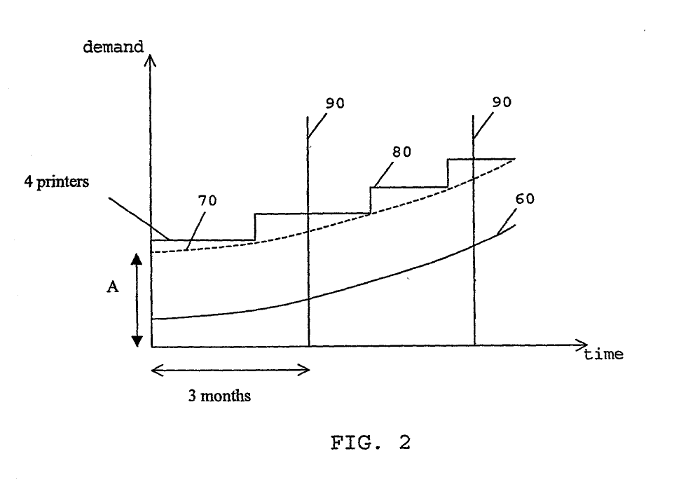

Referring to FIG. 2, the predicted user demand is shown as a first curve 60.

The demand curve 60 is actually a prediction over time of what the output requirements of installed equipment is expected to be.

A straightforward analysis of this curve according to prior art practices might ordinarily be used so as to set the number of printers to be installed to a minimum number, with each printer working to maximum capacity at the peak demand level. Such a philosophy is often adopted where a user is paying the full capital costs of each unit.

In contrast, the method of the present invention applies an over supply function (shown here as being a simple factor of around 2) to the predicted user demand curve to give a safety factored predicted demand function 70. In accordance with this safety factored function, a number of printers which would be required to meet this safety factored demand function and to maintain an output in accordance with that function is calculated and this number of printers is represented by the step function 80.

The actual over supply function chosen is selected so as to reduce demand on the equipment to a level at which acceptable reliability and/or acceptable economic running over time is achievable. Whilst in the Figure it is shown as an applied factor, it will be appreciated that it may be any suitable monotone non-decreasing function calculated to give reliable operation with a degree of redundancy built in to account for equipment failures and possible changes in user demand.

Periodically, it is always desirable for the printer supplier to visit the customer in order to pass on consumables, replace or repair any defective printers etc. In order to provide minimum inconvenience to the customer and to provide a system which is of great utility to the print supplier, such visits should be kept to a minimum and the timing of these visits can also be predicted over time (and will generally be written into a service contract) and are represented on FIG. 2 by the solid rising vertical lines 90.

Typically, the period between such visits 90 may be one or three months. In the FIG. 2, the scheduled visits are indicated as being at three monthly intervals.

Referring in more detail to FIG. 2, it can be seen that a convenient starting number of printers for the user adhering to the safety factored demand curve would be four printers, which can cope with a given demand level A whilst being in substantially constant use. The timing of the first scheduled visit by the representative of the printer supplier actually occurs at a point at which predicted demand shows that five printers would already be required in order to maintain capacity above the safety factored demand curve. Because of this, it may be decided by the printer supplier to actually commence the contract by supplying the customer with five printers from the beginning.

It will be noted from the curve 60 that during the next three month period there is an expected increase in printer usage requiring a further two printers to be installed in order to keep pace with the safety factored predicted demand. In accordance with these predictions, at the first visit by the representative, two further printers may be installed such that, by the time of his second visit, there is still sufficient printer capacity to cope with maximum demand in an economic fashion utilising the printers in their highest reliability band. Of course, it is of note that a short term peak demand could theoretically be satisfied as high as the safety factored demand level.

In an alternative supply model and, where the user is willing and able to do this, extra printers may be installed by the user at times intermediate representative visits. For instance, printer numbers may be increased from five to six, by despatching a new printer to the user around one month after the first visit of the representative, for self-installation by the user. This may be followed by a further printer installation another six weeks later etc., so as to more closely follow the safety factored curve in a step-wise fashion. However, from a user convenience point of view and from the suppliers viewpoint, it may be better for the representative to install all predicted required units for the next given time period so as to meet the safety factored predicted demand during scheduled visit times.

Referring back to FIG. 1, equipment monitoring will be discussed.

There are many means by which actual user demand and correct functioning of the printer equipment can be monitored. In the example shown in FIG. 1, the printer server 50 includes printer management software which monitors the printers to see when they are being used and when not. Real time performance data may be sent from the printers 30 to the printer server 50 using SNMP (Simple Network Management Protocol) and a tool such as “HP OPENVIEW”—data may be organised according to standard printer MIB (Management Information Base) RFC1759 or other proprietary MIBs. In this way, utilisation data is collected. Printer latency (click to clunk) times in particular are also monitored. Alternatively, at the server 40 monitoring of demand may be done by using the API into the spooler. Where user demand is seen to exceed a predicted or an acceptable level, the printer server 50 may be configured to automatically send an email to the printer supplier indicating that more printers will need to be delivered and installed.

There are of course other alternative methods of monitoring user demand and these methods may comprise passive monitoring at the individual printers 30 themselves, or at individual work stations 10. Such methods however are not as flexible as including a dedicated printer server 50, and because of their distributed nature the statistics gained by such monitoring might only be available to the representative during one of the representative's scheduled visits—so there would not be the advantage of having patterns on variation in user demand in advance.

Monitoring of equipment condition may also be done by the printer server 50 under a system of notification, whereby individual printers 30 are provided with the capacity for reporting faults to the server 50.

At the point in time where the printer supplier is notified of a change in user demand or of faults/developing faults by email, the supplier may review the number of printers required to fulfil user demand and may authorise the despatching of extra printers to the user if required. Such extra printers may be sent directly to the user for self-installation, or more preferably (and where sufficient headroom exists between a new predicted user demand curve based on the reported change or changes and the original safety factored curve) may be taken to the user by the representative at the next scheduled visit. Alternatively, where a sharp increase in demand has occurred, a representative from the printer company may make a special visit to the user's premises. It will be appreciated however that in cases of changing user demand, that as long as actual printer usage is unlikely to go over the safety factored predicted usage prior to the next scheduled visit of a representative, installation of extra printers can usefully be delayed so as to avoid extra visits to the user's premises.

Because of the safety factors which are built into the system, any equipment malfunctions may be monitored by the print server 50 and printers which are malfunctioning or which are exhibiting signs indicating that they are likely to malfunction may be repaired or replaced at scheduled visit times.

In the above discussion, the particular method of printer supply adopted refers to applying an oversupply function to the predicted user demand over a given time period so as to provide a safety factored predicted demand function and then calculating the number of equipment units which are required for supply to the user to meet that safety factored predicted demand over the given period. In an alternative, but equivalent, model rather than applying an oversupply function the method may calculate the number of actual equipment units which are required for supply to the user when working within a particular reliability band for those equipment units, to meet the predicted user demand over a given time period. Then, a number of extra equipment units may be added to this calculated number so as to give a certain amount of redundancy. That extra number may be a constant, calculated for the particular time period.

In other words, in the alternative model the number of extra units will reflect both uncertainty in future user demand and account for failure patterns for the equipment. Here, the calculated number for achieving the predicted user demand whilst retaining reliability may be a number “n” of printers, whilst a number of “k” of devices may be provided for the redundancy/headroom, where these “k” devices are on hot, warm or cold standby.

Appropriate levels of redundancy for full tolerance purposes can be calculated from figures giving mean time between failures for the individual printers.

It will be appreciated that in regard to the first method described above, the over supply function referred to may also be such a monotone non-decreasing function.

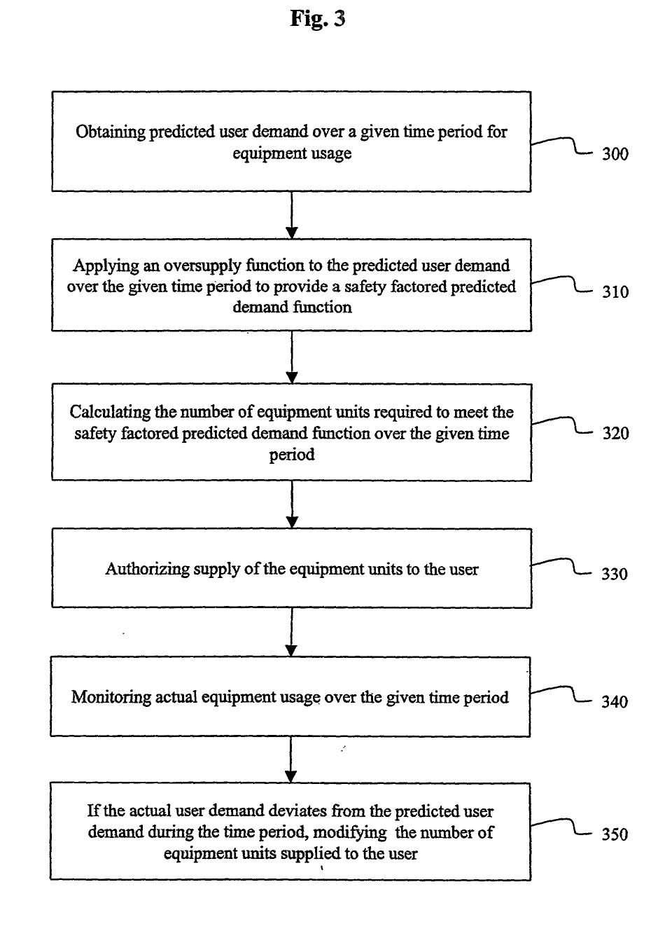

The flowchart for the method and program product discussed previously is shown in FIG. 3. In the flowchart method is shown for equipment supply to a user, the method comprises: (i) obtaining 300 predicted user demand over a given time period for equipment usage and (ii) applying 310 an oversupply function to the predicted user demand over the given time period to provide a safety factored predicted demand function. The method further includes the steps of (iii) calculating 320 the number of equipment units which are required for supply to the user to meet the safety factored predicted demand over the given time period, (iv) authorizing 330 supply of the equipment units to the user, and (v) monitoring 340 actual equipment usage over the given time period. Finally, if actual user demand deviates from predicted user demand during said time period, the method includes (vi) modifying 350 the number of equipment units supplied to the user accordingly at the next convenient opportunity.

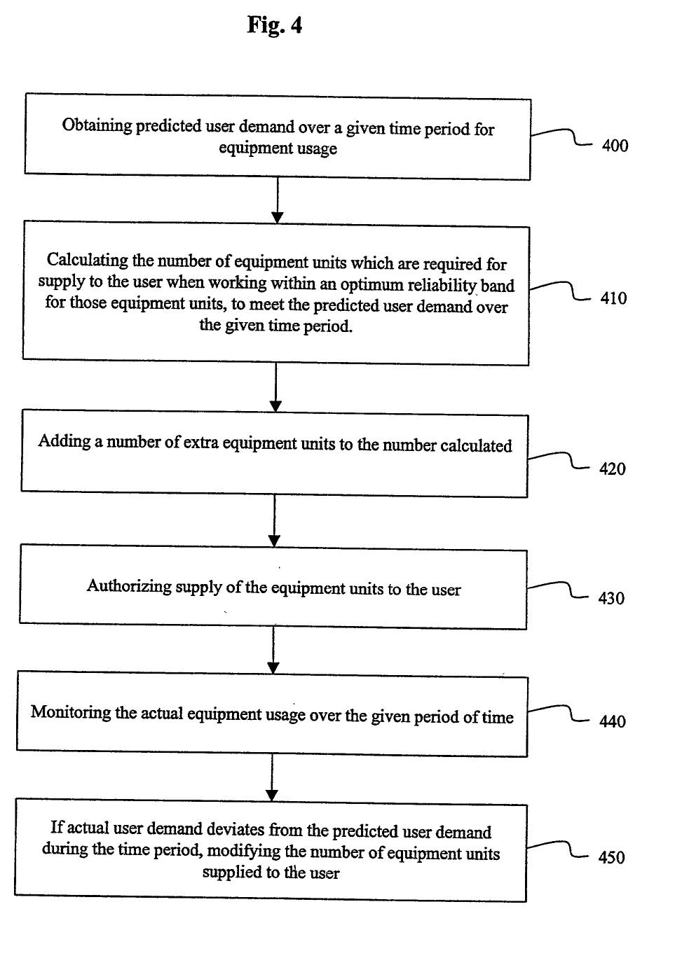

The flowchart of FIG. 4 illustrates a second embodiment of the invention. In FIG. 4 there is provided a method of equipment supply to a user, the method comprising (i) obtaining 400 a predicted user demand over a given time period for equipment usage and (ii) calculating 410 the number of equipment units which are required for supply to the user when working within a reliability band for those equipment units, to meet the predicted user demand over the given time period. The method further includes (iii) adding 420 a number of extra equipment units to the number calculated in step, (iv) authorizing 430 supply of the equipment units to the user, and (v) monitoring 440 actual equipment usage over the given time period. Additionally, if actual user demand deviates from predicted user demand during said time period, the method includes (vi) modifying 450 the number of equipment units supplied to the user accordingly at the next convenient opportunity.

Preferably, in step (i) of the first and second aspects the obtaining a predicted user demand may comprise simply receiving an assessment number from an internal or external source. Alternatively, the step may comprise making an assessment according to maximum output capacity required by the user over the given time period, i.e. according to the predicted maximum output levels required to be produced by the equipment to be supplied. The assessment may be a function which varies over the given time period.

Preferably, the over supply function applied in step (ii) of the first aspect and the number of extra units referred to in step (iii) of the second aspect is calculated in accordance with a usage measure for maintaining reliability of the equipment units to be supplied.

In other words, whilst equipment may have a certain maximum output capacity, reliability or other economic factors are generally not optimum at that level—the over supply function of the first aspect/number of extra units of the second aspect may therefore be calculated for the equipment concerned so as to reduce output demand on the equipment to a level at which acceptable reliability/economic running over time (and taking into account the predicted user demand over time) is achievable.

The oversupply function/number of extra units therefore reflects both the uncertainty with future user demand, and accounts for failure patterns of the equipment.

Uncertainty in user demand may be expressed in a multiplicative factor, failure patterns being expressed in an additive “n+k” redundancy model, where “n” is the required number of devices and “k” devices are on hot, warm or cold standby. “k” is typically a constant.

Appropriate levels of redundancy for fault tolerance purposes can be calculated from figures giving mean-time between failures for the individual pieces of equipment. In general, appropriate over supply functions are monotone non-decreasing functions.

In step (iii) of the first aspect, the calculated number of equipment units is preferably the minimum number of equipment units which are required to meet the peak safety factored predicted demand during said given time period, whereas in step (ii) of the second aspect, this minimum number is the minimum number required to meet peak predicted demand whilst operating in an optimum reliability band.

The given time period may be the time period between desired scheduled visits to the user by an equipment supplier.

The step (iv) of authorizing a supply of the equipment units in the first and second aspects may comprise simply providing an electronic or paper notice internally or externally to a third party to make such supply. Alternatively, the step may include the actual supply of the equipment units.

Monitoring in step (v) of the first and second aspects may comprise monitoring actual equipment usage over the given time period. Monitoring of equipment usage may comprise monitoring requested numbers of print operations over time and may comprise monitoring click to clunk times.

The step (v) of monitoring actual equipment usage may comprise monitoring both actual user demand and equipment condition.

Equipment condition may be monitored by checking for equipment errors and logging such equipment errors.

Equipment condition monitoring may be carried out at a local level at individual equipment units and/or at a system level by monitoring system traffic on a network. Similarly, actual user demand may be monitored at a local level, at a user end or at an equipment unit end, or at a system level.

Preferably, in step (vi) if actual user demand increases above predicted user demand during said time period, then predicted user demand is adjusted in accordance with actual user demand to give a new predicted user demand and then either: in accordance with the first aspect, an oversupply function is applied to the new predicted user demand and a new number of equipment units required for supply to the user to meet a new safety factored predicted demand function is calculated; or in accordance with the second aspect, a number of equipment units required to meet the new predicted user demand is calculated and a number of extra units added to this number to give a new number of equipment units. Thereafter, said new number of equipment units may be supplied and installed by the equipment supplier on the next scheduled visit to the user.

Where, in step (v), monitoring of equipment usage reveals that an equipment unit has become faulty or is likely to become faulty, then provision is made for replacement of that equipment unit during a forthcoming scheduled supplier visit.

Preferably, the equipment comprises printers.

In accordance with the teachings of the invention, a method has been described in which it will be appreciated that when utilisation of printers exceeds a certain threshold believed to give optimum economic performance, then more printers are delivered (free of charge) from the printer supplier to the customer. Alternatively, when the latency (click-to-clunk) of print jobs exceeds a certain threshold more printers may be delivered. Pricing of printer supply may be calculated on the basis of a click charge and may be banded by latency (the lower the latency the higher the price).

In preferred embodiments of the invention, printer drivers are enhanced to interact with the printer management software to allow for latency measurements to be made. When a high enough percentage of print jobs exceeds the latency target for the site, then an email message is sent. Another possible criteria which may be applied to calculate number of printers required is the acceptable percentage of jobs for which a correctly configured printer needs to be available immediately. If the actual percentage falls below that acceptable percentage, then more printers may be supplied.

While the invention has been disclosed as applying to printers, it will be appreciated that the methods described herein may be applied to other types of equipment.

1. A method of equipment supply to a user, the method comprising:
(i) obtaining a predicted user demand over a given time period for equipment usage;
(ii) applying an oversupply function to the predicted user demand over the given time period to provide a safety factored predicted demand function;
(iii) calculating the number of equipment units which are required for supply to the user to meet the safety factored predicted demand over the given time period;
(iv) authorizing supply of the equipment units to the user;
(v) monitoring actual equipment usage over the given time period; and
(vi) if actual user demand deviates from predicted user demand during said time period modifying the number of equipment units supplied to the user accordingly at the next convenient opportunity.

2. The method of claim 1, wherein in step (i) the obtaining the predicted user demand comprises making an assessmen according to maximum output capacity required by the user over the given time period.

3. The method of claim 1, wherein in step (iii) the calculated number of equipment units is the minimum number of equipment units which are required to meet the peak safety factored predicted demand during said given time period.

4. The method of claim 1, wherein the given time period is the time period between desired scheduled visits to the user by an equipment supplier.

5. The method of claim 1, wherein the over supply function applied in step (ii) is calculated in accordance with a usage measure for maintaining reliability of the equipment units to be supplied.

6. The method of claim 5, wherein the oversupply function is compiled with regard to the meantime between failures of the equipment at different load levels.

7. The method of claim 1, wherein the monitoring in step (v) comprises monitoring actual equipment usage over the given time period.

8. The method of claim 1, wherein the step (v) of monitoring actual equipment usage comprises monitoring both actual user demand and equipment condition.

9. The method of claim 1, wherein in step (vi) if actual user demand increases above predicted user demand during said time period, then adjusting predicted user demand in accordance with actual user demand to give a new predicted user demand and applying an oversupply function to the new predicted user demand and calculating a number of further equipment units required for supply to the user to meet a new safety factored predicted demand function.

10. The method of claim 1, wherein if in step (v), monitoring of equipment usage reveals that an equipment unit has become faulty or is likely to become faulty, then sending a notice.

11. A method of equipment supply to a user, the method comprising:
(i) obtaining predicted user demand over a given time period for equipment usage;
(ii) calculating the number of equipment units which are required for supply to the user when working within an optimum reliability band for those equipment units, to meet the predicted user demand over the given time period;
(iii) adding a number of extra equipment units to the number calculated in step (ii);
(iv) authorizing supply of the equipment units to the user;
(v) monitoring actual equipment usage over the given time period; and
(vi) if actual user demand deviates from predicted user demand during said time period, modifying the number of equipment units supplied to the user accordingly at the next convenient opportunity.

12. The method of claim 11, wherein in step (i) the obtaining predicted user demand comprises making an assessment according to maximum output capacity required by the user over the given time period.

13. The method of claim 11, wherein in step (ii) the calculated number of equipment units is the minimum number of equipment units which are required to meet the peak predicted demand during said given time period.

14. The method of claim 11, wherein the given time period is the time period between desired scheduled visits to the user by an equipment supplier.

15. The method of claim 11, wherein the extra number of equipment units in step (iii) is calculated in accordance with a usage measure for maintaining reliability of the equipment units to be supplied.

16. The method of claim 15, wherein the extra number is compiled with regard to the meantime between failures of the equipment at different load levels.

17. The method of claim 11, wherein the monitoring in step (v) comprises monitoring actual equipment usage over the given time period.

18. The method of claim 11, wherein the step (v) of monitoring actual equipment usage comprises monitoring both actual user demand and equipment condition.

19. The method of claim 11, wherein in step (vi) if actual user demand increases above predicted user demand during said time period, then adjusting predicted user demand in accordance with actual user demand to give a new predicted user demand and calculating a number of further equipment units required for supply to the user to meet the new predicted user demand, whilst operating in the optimum reliability band, and an extra number added to the calculated number to give a new number, said new number of equipment units being supplied and installed by the equipment supplier on the next scheduled visit to the user.

20. The method of claim 11, wherein if in step (v), monitoring of equipment usage reveals that an equipment unit has become faulty or is likely to become faulty, then provision is made for replacement of that equipment unit during a forthcoming scheduled supplier visit.

21. The method of claim 11, wherein the equipment comprises printers.

22. A program product for a method of equipment supply to a user, comprising machine readable program code to cause a machine to perform the following method steps:
(i) obtaining a predicted user demand over a given time period for equipment usage;
(ii) applying an oversupply function to the predicted user demand over the given time period to provide a safety factored predicted demand function;
(iii) calculating the number of equipment units which are required for supply to the user to meet the safety factored predicted demand over the given time period;
(iv) authorizing supply of the equipment units to the user;
(v) monitoring actual equipment usage over the given time period; and
(vi) if actual user demand deviates from predicted user demand during said time period modifying the number of equipment units supplied to the user accordingly at the next convenient opportunity.

23. A program product for a method of equipment supply to a user, comprising machine readable program code for causing a machine to perform the following method steps:
(i) obtaining predicted user demand over a given time period for equipment usage;
(ii) calculating the number of equipment units which are required for supply to the user when working within an optimum reliability band for those equipment units, to meet the predicted user demand over the given time period;
(iii) adding a number of extra equipment units to the number calculated in step (ii);
(iv) authorizing supply of the equipment units to the user;
(v) monitoring actual equipment usage over the given time period; and
(vi) if actual user demand deviates from predicted user demand during said time period, modifying the number of equipment units supplied to the user accordingly at the next convenient opportunity.

24. A system for equipment supply to a user, comprising:
(i) a component for obtaining a predicted user demand over a given time period for equipment usage;
(ii) a component for applying an oversupply function to the predicted user demand over the given time period to provide a safety factored predicted demand function;
(iii) a component for calculating the number of equipment units which are required for supply to the user to meet the safety factored predicted demand over the given time period;
(iv) a component for authorizing the supply of the equipment units to the user;
(v) a component for monitoring actual equipment usage over the given time period; and
(vi) a component for, if actual user demand deviates from predicted user demand during said time period modifying the number of equipment units supplied to the user accordingly at the next convenient opportunity.

25. A system for equipment supply to a user, comprising:
(i) a component for obtaining predicted user demand over a given time period for equipment usage;
(ii) a component for calculating the number of equipment units which are required for supply to the user when working within an optimum reliability band for those equipment units, to meet the predicted user demand over the given time period;
(iii) a component for adding a number of extra equipment units to the number calculated in step (ii);
(iv) a component for authorizing supply of the equipment units to the user;
(v) a component for monitoring actual equipment usage over the given time period; and
(vi) a component for, if actual user demand deviates from predicted user demand during said time period, modifying the number of equipment units supplied to the user accordingly at the next convenient opportunity.
